(19) United States
(12) Patent Application Publication
(10) Pub. No.: US 2021/0119336 A1
(43) Pub. Date: Apr. 22, 2021

(54) Dual-Feed Dual-Band MIMO Antenna Apparatus And Terminal

(71) Applicant: Huawei Technologies Co., Ltd., Shenzhen (CN)

(72) Inventors: Qiao Sun, Xi'an (CN); Bao Lu, Shenzhen (CN); Kun Li, Xi'an (CN)

(21) Appl. No.: 16/771,058

(22) PCT Filed: Dec. 27, 2017
(86) PCT No.: PCT/CN2017/118786

§ 371 Date: Jun. 9, 2020

(51) Int. Cl. H01Q 5/35; H01Q 21/28; H01Q 1/52

(52) U.S. Cl. CPC H01Q 5/35; H01Q 1/521; H01Q 21/28

(57) ABSTRACT

A dual-feed dual-band multiple-input and multiple-output (MIMO) antenna apparatus includes an antenna radiator, a first feed port, a second feed port, a first filter unit, and a second filter unit. The first feed port and the second feed port are spaced on the antenna radiator in a length direction of the antenna radiator. The first filter unit is disposed between the first feed port and the antenna radiator, and the second filter unit is disposed between the second feed port and the antenna radiator. The first filter unit is configured to pass a frequency component within a first preset frequency range, and filter out a frequency component outside the first preset frequency range; and the second filter unit is configured to filter out a frequency component within a second preset frequency range, and pass a frequency component outside the second preset frequency range.

### TECHNICAL FIELD

This application relates to the field of antenna technologies, and in particular, to a dual-feed dual-band MIMO antenna apparatus and a terminal.

### BACKGROUND

As multiple-input multiple-output (Multiple-Input Multiple-Output, MIMO) is popularly applied, a higher requirement is currently imposed on an antenna design. In some designs to which the MIMO is applied, another two antennas need to be designed in original space.

In the prior art, a diversity antenna is separately designed in a MIMO antenna design. FIG. 1 is a schematic diagram of a dual wireless-fidelity (Wireless-Fidelity, Wifi) antenna in the prior art. As shown in FIG. 1, Wifi 1 and Wifi 2 are two separate Wifi antennas, to implement wifi MIMO.

However, currently, with a development trend of a large screen-to-body ratio and multi-camera of a terminal, antenna clearance is greatly reduced, and antenna arrangement space is increasingly limited. Consequently, the arrangement manner, namely, the diversity antenna solution in the prior art is no longer applicable. Therefore, currently, how to arrange more antennas in very small space and ensure high performance of the antennas becomes a technical problem that needs to be urgently resolved.

### SUMMARY

Embodiments of this application provide a dual-feed dual-band MIMO antenna apparatus and a terminal, so that not only more antennas can be arranged in very small space, but also high performance of the antennas can be ensured.

With reference to the foregoing, according to a first aspect, an embodiment of this application provides a dual-feed dual-band MIMO antenna apparatus, including: an antenna radiator, a first feed port, a second feed port, a first filter unit, and a second filter unit, where

the first feed port and the second feed port are spaced on the antenna radiator in a length direction of the antenna radiator, and there is a spacing between the first feed port and an end of the antenna radiator;

the first filter unit is disposed between the first feed port and the antenna radiator, and the second filter unit is disposed between the second feed port and the antenna radiator; and

the first filter unit is configured to pass a frequency component within a first preset frequency range, and filter out a frequency component outside the first preset frequency range; and the second filter unit is configured to filter out a frequency component within a second preset frequency range, and pass a frequency component outside the second preset frequency range.

In this solution, the first feed port and the second feed port are separately designed, but share a same radiator. In this way, 5G wifi MIMO can be implemented on the same radiator, and a total quantity of antennas is reduced, so that not only antennas can be normally arranged in very small space, but also high performance of the antennas can be ensured.

In a possible implementation, the second feed port is located at an end, of the antenna radiator, far from the first feed port.

In this solution, the second feed port 3 is disposed at the end of the antenna radiator 1, to improve antenna isolation.

In a possible implementation, there is a spacing between the second feed port and an end of the antenna radiator.

In a possible implementation, the antenna radiator includes a first radiation section and a second radiation section that are connected to each other, the first radiation section is located on a side of the first feed port, and the second radiation section is located between the first feed port and the second feed port.

In a possible implementation, the first radiation section and the second radiation section are in an integrated structure.

In a possible implementation, the first radiation section is located on the side, of the first feed port, far from the second feed port.

In a possible implementation, the first radiation section and the second radiation section are located on a same side of the first feed port.

In a possible implementation, the apparatus further includes a second radiator; and

the second radiator is connected to the second feed port.

In the foregoing solution, a GPS, 2.4G wifi MIMO, and 5G wifi MIMO may be implemented by using a same antenna, so that fewer antennas can be arranged in an architecture, and space occupied by the antennas can be reduced.

In a possible implementation, the first feed port is a 2.4G wireless fidelity WIFI feed port, and the second feed port is a global positioning system GPS feed port.

In this solution, the GPS feed port and the 2.4G wifi feed port are separately designed, but may share a same radiator, so that radio frequency conduction and sensitivity can be improved compared with that in a case in which the GPS feed port and the 2.4G wifi feed port are a same feed port. Radio frequency conduction and sensitivity in the GPS can increase by 0.5 dB, and radio frequency conduction and sensitivity in the 2.4G wifi can increase by 0.7 dB.

Further, 5G wifi MIMO is implemented on the same radiator, so that a total quantity of antennas is reduced, and antennas can be arranged more flexibly.

In a possible implementation, the first feed port is a feed port of an LTE B8 frequency band, and the second feed port is a feed port of an LTE B3 frequency band.

In a possible implementation, the first filter unit is a band-pass filter, and the second filter unit is a band-stop filter.

In a possible implementation, the first filter unit includes a first inductor and a first capacitor, a first end of the first inductor is connected to the first feed port, a second end of the first inductor is connected to a first end of the first capacitor, and a second end of the first capacitor is grounded.

In a possible implementation, the second filter unit includes a second capacitor and a second inductor, the second capacitor and the second inductor are connected in parallel, the antenna radiator is separately connected to a first end of the second inductor and a first end of the second capacitor, and the second feed port is separately connected to a second end of the second inductor and a second end of the second capacitor.

In the foregoing solution, the second capacitor and the second inductor are connected in parallel to form the second filter unit, so as to optimize isolation.

In a possible implementation, the second capacitor includes a fixed-value capacitor or a variable capacitor.

In the foregoing solution, the inductor and the variable capacitor are connected in parallel to form the second filter unit, so as to optimize isolation.

In a possible implementation, the second filter unit includes a third capacitor, a third inductor, and a fourth inductor, a first end of the third inductor is separately connected to a first end of the fourth inductor and the antenna radiator, a second end of the third inductor is separately connected to a second end of the third capacitor and the second feed port, and a second end of the fourth inductor is connected to a first end of the third capacitor.

In the foregoing solution, the fourth inductor and the third capacitor are connected in series, and then are connected to the third inductor L3 in parallel, to form the second filter unit, so as to optimize isolation.

In a possible implementation, the second filter unit includes a fifth inductor, a fourth capacitor, and a fifth capacitor, a first end of the fifth inductor is separately connected to a first end of the fourth capacitor and the antenna radiator, a second end of the fifth inductor is separately connected to a second end of the fourth capacitor and a first end of the fifth capacitor, and a second end of the fifth capacitor is connected to the second feed port.

In the foregoing solution, the fifth inductor and the fourth capacitor are connected in parallel, and then are connected to the fifth capacitor in series, to form the second filter unit, so as to optimize isolation.

According to a second aspect, an embodiment of this application provides a terminal, including the dual-feed dual-band MIMO antenna apparatus according to the first aspect.

The embodiments of this application provide the dual-feed dual-band MIMO antenna apparatus and the terminal. The dual-feed dual-band MIMO antenna apparatus includes the antenna radiator, the first feed port, the second feed port, the first filter unit, and the second filter unit. The first feed port and the second feed port are spaced on the antenna radiator in the length direction of the antenna radiator, and there is the spacing between the first feed port and the end of the antenna radiator. The first filter unit is disposed between the first feed port and the antenna radiator, and the second filter unit is disposed between the second feed port and the antenna radiator. The first filter unit is configured to pass the frequency component within the first preset frequency range, and filter out the frequency component outside the first preset frequency range; and the second filter unit is configured to filter out the frequency component within the second preset frequency range, and pass the frequency component outside the second preset frequency range. The first feed port and the second feed port are separately designed, but share a same radiator. In this way, 5G wifi MIMO can be implemented on the same radiator, and a total quantity of antennas is reduced, so that not only antennas can be normally arranged in very small space, but also high performance of the antennas can be ensured.

### BRIEF DESCRIPTION OF DRAWINGS

FIG. 1A is a schematic structural diagram of a dual-feed dual-band MIMO antenna apparatus according to this application;

FIG. 1B is another schematic structural diagram of a dual-feed dual-band MIMO antenna apparatus according to this application.

FIG. 1C is still another schematic structural diagram of a dual-feed dual-band MIMO antenna apparatus according to this application:

FIG. 2 is a schematic simulation diagram of a return loss characteristic S11 of a dual-feed dual-band MIMO antenna apparatus;

FIG. 3 to FIG. 7 are schematic diagrams of current distribution;

FIG. 8 is a schematic diagram of simulation system efficiency of a dual-feed dual-band MIMO antenna apparatus:

FIG. 9 is another schematic simulation diagram of a return loss characteristic S11 of a dual-feed dual-band MIMO antenna apparatus;

FIG. 10 is still another schematic structural diagram of a dual-feed dual-band MIMO antenna apparatus according to this application;

FIG. 11 is still another schematic simulation diagram of a return loss characteristic S11 of a dual-feed dual-band MIMO antenna apparatus;

FIG. 12 to FIG. 18 are schematic diagrams of current distribution;

FIG. 19 is another schematic diagram of simulation system efficiency of a dual-feed dual-band MIMO antenna apparatus;

FIG. 20A is a schematic structural diagram of a second filter unit;

FIG. 20B is another schematic structural diagram of a second filter unit:

FIG. 20C is still another schematic structural diagram of a second filter unit:

FIG. 20D is still another schematic structural diagram of a second filter unit; and

FIG. 21 is a schematic structural diagram of an embodiment of a terminal according to this application.

### DESCRIPTION OF EMBODIMENTS

In an existing MIMO antenna design, a diversity antenna is separately designed. However, with a development trend of a large screen-to-body ratio and multi-camera of a terminal, antenna clearance is greatly reduced, and antenna arrangement space is increasingly limited. Therefore, how to arrange more antennas in very small space and ensure high performance of the antennas is a technical problem that needs to be resolved in this application.

A terminal in this application may include but not be limited to a mobile phone, a tablet computer, a wearable device, and the like.

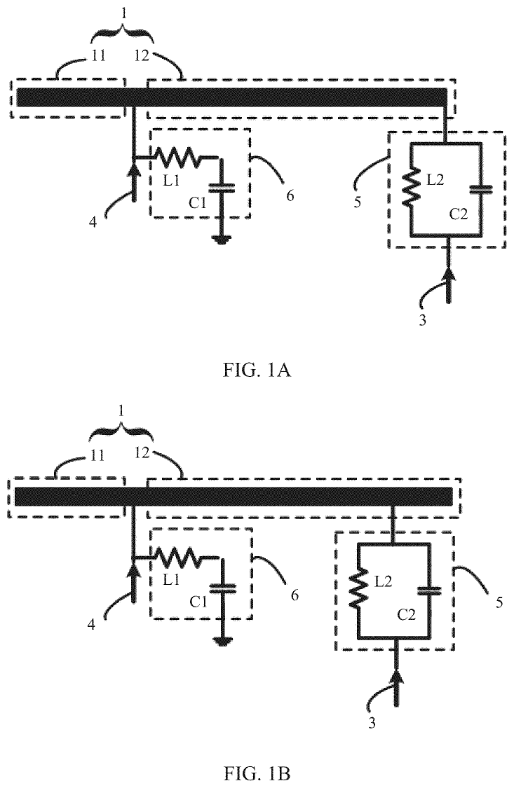

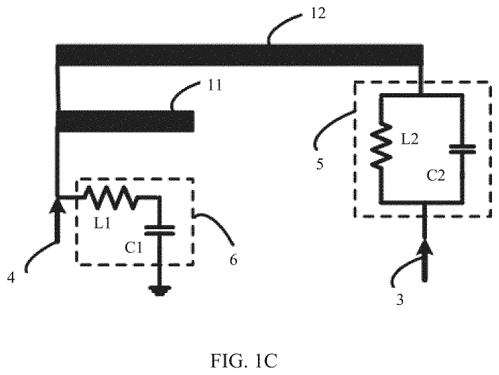

FIG. 1A is a schematic structural diagram of a dual-feed dual-band MIMO antenna apparatus according to this application. As shown in FIG. 1A, the dual-feed dual-band MIMO antenna apparatus includes an antenna radiator 1, a first feed port 4, a second feed port 3, a first filter unit 6, and a second filter unit 5.

The first feed port 4 and the second feed port 3 are spaced on the antenna radiator 1 in a length direction of the antenna radiator 1, and there is a spacing between the first feed port 4 and an end of the antenna radiator 1. The first filter unit 6 is disposed between the first feed port 4 and the antenna radiator 1, and the second filter unit 5 is disposed between the second feed port 3 and the antenna radiator 1. The first filter unit 6 is configured to pass a frequency component within a first preset frequency range, and filter out a frequency component outside the first preset frequency range; and the second filter unit 5 is configured to filter out a frequency component within a second preset frequency range, and pass a frequency component outside the second preset frequency range.

Specifically, both the first feed port 4 and the second feed port 3 are disposed on the antenna radiator 1. In an optional implementation, the first feed port 4 is disposed in a position at a specific distance from the end of the antenna radiator 1, and the second feed port 3 is disposed at an end, of the antenna radiator 1, far from the first feed port 4. The second feed port 3 is disposed at the end of the antenna radiator 1, to improve antenna isolation.

In another optional implementation, FIG. 1B is another schematic structural diagram of a dual-feed dual-band MIMO antenna apparatus according to this application. As shown in FIG. 1B, there is a spacing between the second feed port 3 and an end of the antenna radiator 1. In this way, the second feed port 3 may be disposed in a position at a specific distance from the end of the antenna radiator 1, so that the second feed port 3 is disposed in a relatively flexible position.

In addition, still referring to FIG. 1A, the antenna radiator 1 includes a first radiation section 11 and a second radiation section 12 that are connected to each other. The first radiation section 11 is located on a side of the first feed port 4, and the second radiation section 12 is located between the first feed port 4 and the second feed port 3.

Specifically, the first radiation section 11 and the second radiation section 12 are in an integrated structure. In other words, the first radiation section 11 may be used as a branch of the second radiation section 12. Optionally, the first radiation section 11 may be located on a side, of the first feed port 4, far from the second feed port 3.

In another possible implementation, FIG. 1C is still another schematic structural diagram of a dual-feed dual-band MIMO antenna apparatus according to this application. As shown in FIG. 1C, the first radiation section 11 and the second radiation section 12 may be located on a same side of the first feed port 4.

The first feed port 4 is connected to both an end of the first radiation section 11 and an end of the second radiation section 12. In actual application, the dual-feed dual-band MIMO antenna apparatus in FIG. 1A, FIG. 1B, or FIG. 1C may be selected according to different actual situations or different use environments. For example, when antennas are arranged in larger space, the antenna apparatus shown in FIG. 1A or FIG. 1B may be selected. When antennas are arranged in smaller space, the antenna apparatus shown in FIG. 1C may be selected.

Still referring to FIG. 1A to FIG. 1C, the first filter unit 6 is disposed between the first feed port 4 and the antenna radiator 1, and the second filter unit 5 is disposed between the second feed port 3 and the antenna radiator 1. In a possible implementation, the first filter unit 6 is a band-pass filter, and the second filter unit 5 is a band-stop filter. In addition, the first filter unit 6 may be further another device, provided that the first filter unit 6 can implement functions of passing the frequency component within the first preset frequency range and filtering out the frequency component outside the first preset frequency range. The second filter unit 5 may be further another device, provided that the second filter unit 5 can implement functions of filtering out the frequency component within the second preset frequency range and passing the frequency component outside the second preset frequency range.

In addition, the first feed port 4 is a 2.4G wireless fidelity WIFI feed port, and the second feed port 3 is a global positioning system (Global Positioning System, GPS) feed port. A person skilled in the art may understand that, when the first filter unit 6 is a band-pass filter of a GPS frequency band and the second filter unit 5 is a 2.4G WIFI band-stop filter, the second feed port 3 generates two resonances covering the GPS frequency band and a 5G wifi frequency band, and the first feed port 4 generates one resonance covering a 2.4G wifi frequency band and two resonances covering the 5G wifi frequency band. Therefore, the dual-feed dual-band MIMO antenna apparatus shown in FIG. 1A to FIG. 1C can cover the GPS frequency band and the 2.4G wifi frequency band, and 5G wifi MIMO can be implemented.

In this embodiment, the GPS feed port and the 2.4G wifi feed port are separately designed, but may share a same radiator, so that radio frequency conduction and sensitivity can be improved compared with that in a case in which the GPS feed port and the 2.4G wifi feed port are a same feed port. Radio frequency conduction and sensitivity in the GPS can increase by 0.5 dB, and radio frequency conduction and sensitivity in the 2.4G wifi can increase by 0.7 dB.

In addition, the first feed port and the second feed port share a same radiator, so that a radio frequency power splitter can be omitted, and costs can be reduced.

Further, the 5G wifi MIMO is implemented on the same radiator, so that a total quantity of antennas is reduced, and antennas can be arranged more flexibly.

Optionally, the first feed port 4 is a feed port of a long term evolution (Long Term Evolution, LTE) B8 frequency band, and the second feed port 3 is a feed port of an LTE B3 frequency band. A person skilled in the art may understand that, when the first filter unit 6 is a band-pass filter of the B8 frequency band, and the second filter unit 5 is a band-stop filter of the B3 frequency band, the dual-feed dual-band MIMO antenna apparatus shown in FIG. 1A to FIG. 1C may implement LTE B8, LTE B3, and LTE B7 MIMO. The LTE B8 frequency band is 880 MHz to 960 MHz, the LTE B3 frequency band is 1710 MHz to 1880 MHz, and an LTE B7 frequency band is 2500 MHz to 2690 MHz.

It should be noted that FIG. 1A to FIG. 1C show a position relationship between components in the dual-feed dual-band MIMO antenna apparatus, but does not limit a proportion relationship of sizes of the components.

The dual-feed dual-band MIMO antenna apparatus provided in this embodiment of this application includes the antenna radiator, the first feed port, the second feed port, the first filter unit, and the second filter unit. The first feed port and the second feed port are spaced on the antenna radiator in the length direction of the antenna radiator, and there is the spacing between the first feed port and the end of the antenna radiator. The first filter unit is disposed between the first feed port and the antenna radiator, and the second filter unit is disposed between the second feed port and the antenna radiator. The first filter unit is configured to pass a frequency component within the first preset frequency range, and filter out the frequency component outside the first preset frequency range; and the second filter unit is configured to filter out the frequency component within the second preset frequency range, and pass the frequency component outside the second preset frequency range. The first feed port and the second feed port are separately designed, but share a same radiator. In this way, the 5G wifi MIMO can be implemented on the same radiator, and the total quantity of antennas is reduced, so that not only antennas can be normally arranged in very small space, but also high performance of the antennas can be ensured.

The foregoing describes several possible structural forms of the dual-feed dual-band MIMO antenna apparatus. The following describes operating principles of the dual-feed dual-band MIMO antenna apparatus in the several structural forms.

In the dual-feed dual-band MIMO antenna apparatus shown in FIG. 1A to FIG. 1C, an example in which the first feed port 4 is a 2.4G WIFI feed port, the second feed port 3 is a GPS feed port, the first filter unit 6 is a band-pass filter of the GPS frequency band, and the second filter unit 5 is a 2.4G WIFI band-stop filter is first described.

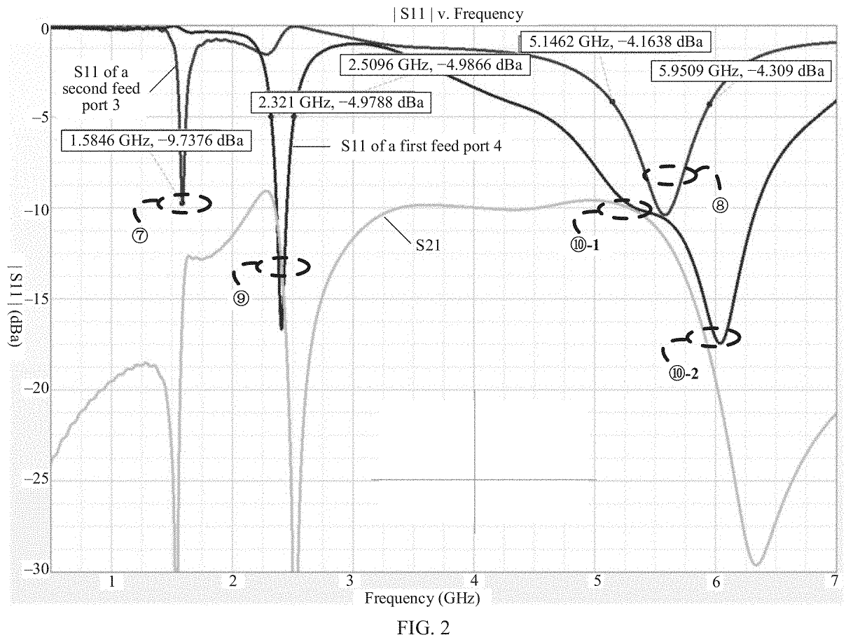

FIG. 2 is a schematic simulation diagram of a return loss characteristic S1 of a dual-feed dual-band MIMO antenna apparatus. As shown in FIG. 2, the second feed port 3 generates two resonances covering the GPS frequency band (a resonance \textcircled{7}) and a 5G wifi frequency band (a resonance \textcircled{8}), and the first feed port 4 generates one resonance covering the 2.4G wifi frequency band (a resonance \textcircled{9}) and two resonances covering the 5G wifi frequency band (a resonance \textcircled{10}-1 and a resonance \textcircled{10}-2). Therefore, the dual-feed dual-band MIMO antenna apparatus can cover the GPS frequency band and the 2.4G wifi frequency band, and the 5G wifi MIMO can be implemented.

Still referring to FIG. 2, the dual-feed dual-band MIMO antenna apparatus shown in FIG. 1A and FIG. 1B is used as an example. A person skilled in the art may understand that a mode of the resonance \textcircled{7} is a left-hand mode, a main radiator of the resonance \textcircled{7} is the second radiation section 12, and a corresponding current distribution diagram is shown in FIG. 3. It can be learned from FIG. 3 that currents are basically distributed on the second radiation section 12.

It should be noted that, because the GPS frequency band (the resonance \textcircled{7}) is in the left-hand mode, the second feed port 3 is at a top of an entire machine, and an upper hemisphere ratio of an antenna radiation pattern is relatively good and is greater than −3 dB. The 2.4G wifi frequency band is in a unipole antenna mode, the first feed port 4 is on a side edge of the entire machine, and a hemisphere ratio of an antenna radiation pattern is relatively good and is greater than −3 dB.

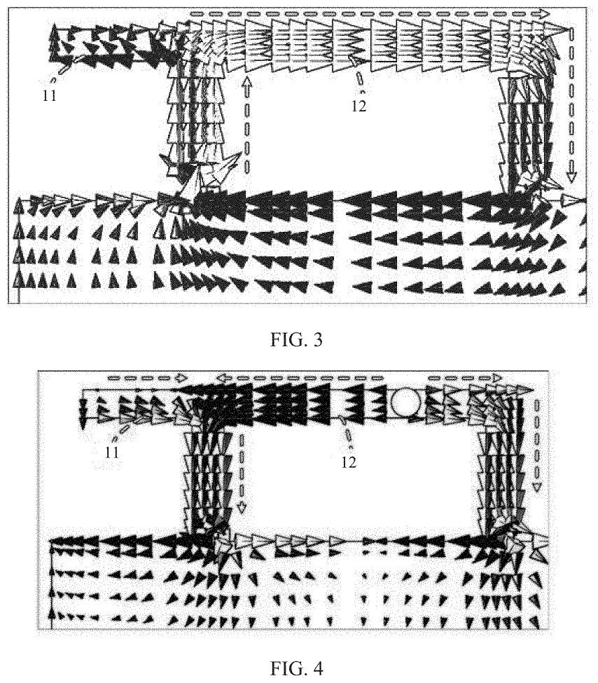

A mode of the resonance \textcircled{8} is a half-wavelength mode of a loop antenna, a main radiator is the second radiation section 12, and a corresponding current distribution diagram is shown in FIG. 4. It can be learned from FIG. 4 that currents are basically distributed on the second radiation section 12.

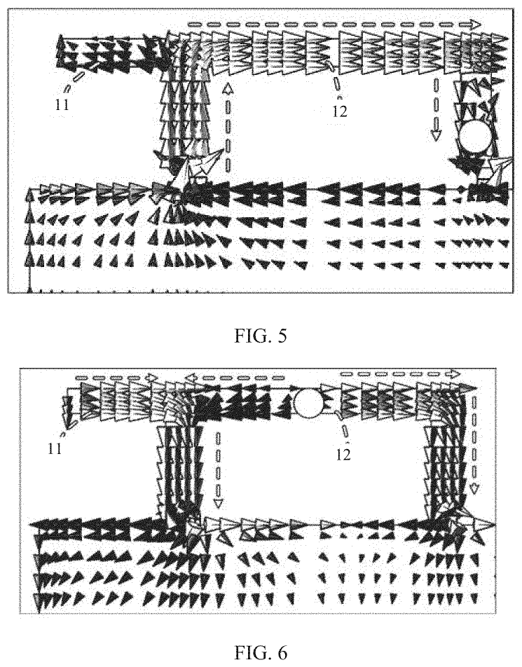

A mode of the resonance \textcircled{9} is a quarter wavelength mode of a unipole antenna, a main radiator is the second radiation section 12, and a corresponding current distribution diagram is shown in FIG. 5. It can be learned from FIG. 5 that currents are basically distributed on the second radiation section 12.

A mode of the resonance \textcircled{10}-1 is a half-wavelength mode of a loop antenna, a main radiator is the second radiation section 12, and a corresponding current distribution diagram is shown in FIG. 6. It can be learned from FIG. 6 that currents are basically distributed on the second radiation section 12.

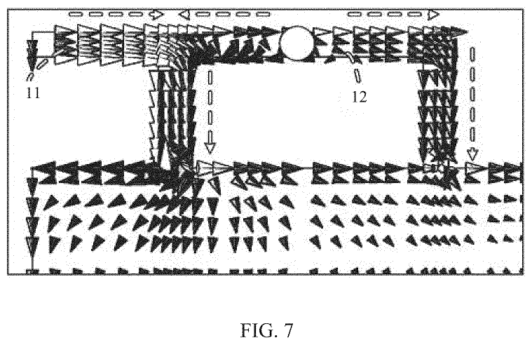

A mode of the resonance \textcircled{10}-2 is a three-quarters wavelength mode of an inverted F antenna (Inverted F antenna, IFA), a main radiator is the first radiation section 11, and a corresponding current distribution diagram is shown in FIG. 7. It can be learned from FIG. 7 that currents are basically distributed on the first radiation section 11.

As shown in FIG. 2, smallest isolation S21 between the resonance \textcircled{8} and the resonance \textcircled{10}-1 is −9.5 dB, and isolation S21 between the resonance \textcircled{8} and the resonance \textcircled{10}-2 is below −10 dB, so that a requirement of MIMO can be met.

It should be noted that, as shown in FIG. 2, modes of the resonance \textcircled{10}-1 and the resonance \textcircled{10}-2 are different, and modes of the resonance \textcircled{10}-1 and the resonance \textcircled{8} are the same. Therefore, antenna isolation is relatively poor. However, the modes of the resonance \textcircled{10}-2 and the resonance \textcircled{8} are different, and therefore antenna isolation is relatively good.

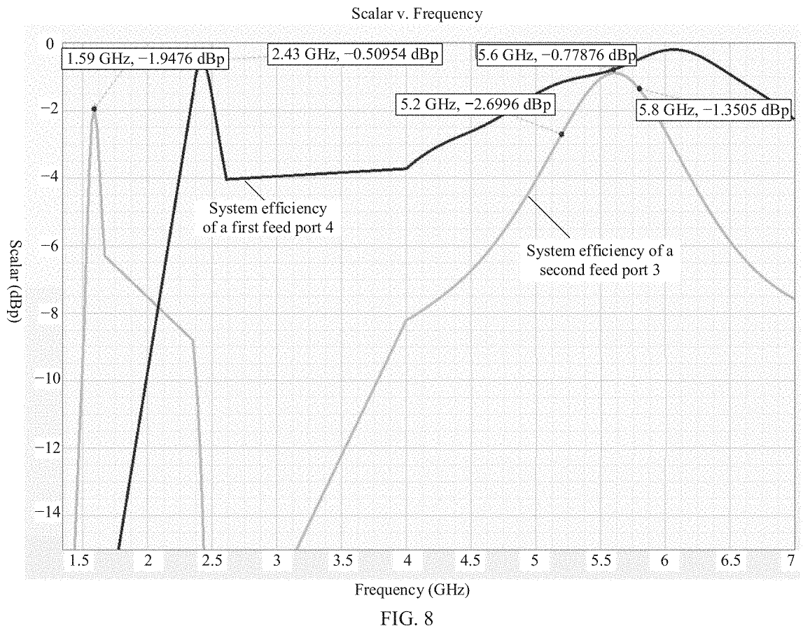

Further, FIG. 8 is a schematic diagram of simulation system efficiency of a dual-feed dual-band MIMO antenna apparatus. As shown in FIG. 8, system efficiency of the first feed port 4 and the second feed port 3 may be determined through simulation. When efficiency is relatively high, an actual requirement can be met.

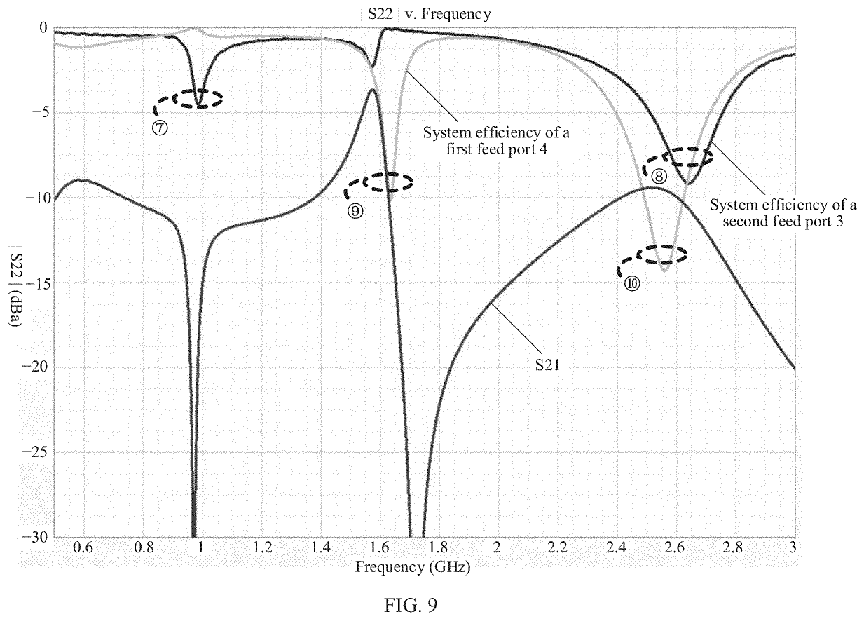

FIG. 9 is another schematic simulation diagram of a return loss characteristic S11 of a dual-feed dual-band MIMO antenna apparatus. As shown in FIG. 9, the dual-feed dual-band MIMO antenna apparatus shown in FIG. 1A and FIG. 1B is used as an example. The first feed port 4 is a feed port of the LTE B8 frequency band, and the second feed port 3 is a feed port of the LTE B3 frequency band. When the first filter unit 6 is a band-pass filter of the B8 frequency band, and the second filter unit 5 is a band-stop filter of the B3 frequency band, the second feed port 3 generates two resonances covering the LTE B8 frequency band (a resonance \textcircled{7}) and the LTE B7 frequency band (a resonance \textcircled{8}), and the first feed port 4 generates two resonances covering the LTE B3 frequency band (a resonance \textcircled{9}) and the LTE B7 frequency band (a resonance \textcircled{10}). Therefore, the dual-feed dual-band MIMO antenna apparatus can implement LTE B8, LTE B3, and LTE B7 MIMO. The LTE B8 frequency band is 880 MHz to 960 MHz, the LTE B3 frequency band is 1710 MHz to 1880 MHz, and the LTE B7 frequency band is 2500 MHz to 2690 MHz.

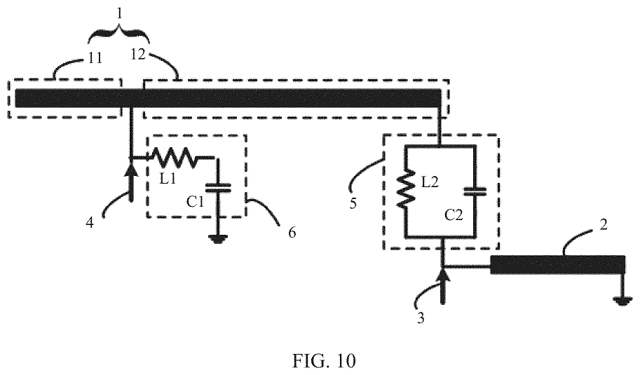

Optionally, FIG. 10 is still another schematic structural diagram of a dual-feed dual-band MIMO antenna apparatus according to this application. As shown in FIG. 10, the dual-feed dual-band MIMO antenna apparatus further includes a second radiator 2. The second radiator 2 is connected to the second feed port 3.

Specifically, as shown in FIG. 10, the first feed port 4 and the second feed port 3 are disposed on two sides of the antenna radiator 1, one end of the second radiator 2 is separately connected to the second feed port 3 and the second filter unit 5, and the other end of the second radiator 2 is grounded. The second radiator 2 is a grounding branch of the second feed port 3, the second feed port 3 is a GPS feed port, the first feed port 4 is a 2.4G wifi feed port, the second filter unit 5 is a 2.4G wifi band-stop filter, and the first filter unit 6 is a band-pass filter of the GPS frequency band.

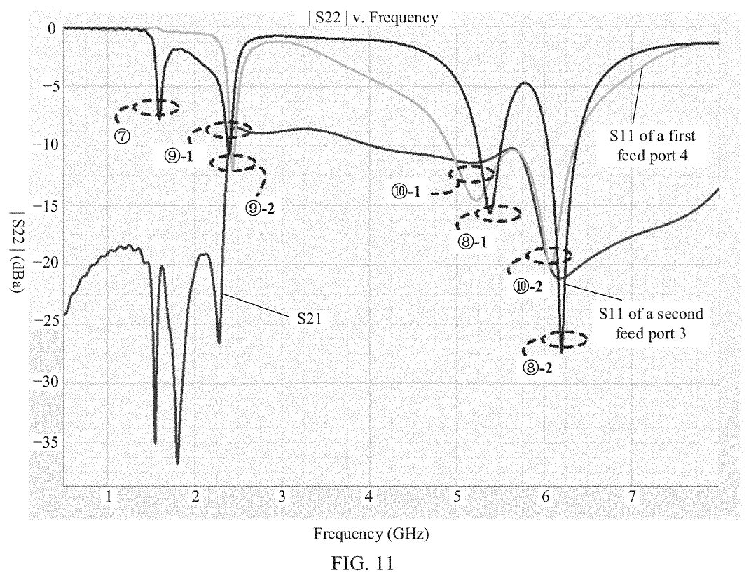

FIG. 11 is still another schematic simulation diagram of a return loss characteristic S11 of a dual-feed dual-band MIMO antenna apparatus. As shown in FIG. 11, resonances generated by the second feed port 3 can cover the GPS frequency band (a resonance \textcircled{7}), the 2.4G wifi frequency band (a resonance \textcircled{9}-1), and the 5G wifi frequency band (a resonance \textcircled{8}-1 and a resonance \textcircled{8}-2), and resonances generated by the first feed port 4 can cover the 2.4G wifi frequency band (a resonance \textcircled{9}-2) and the 5G wifi frequency band (a resonance \textcircled{10}-1 and a resonance \textcircled{10}-2). Therefore, the dual-feed dual-band MIMO antenna apparatus can implement a GPS, 2.4G wifi MIMO, and 5G wifi MIMO.

In this embodiment, because the second filter unit 5 is the 2.4G wifi band-stop filter, isolation between the resonance \textcircled{9}-1 and the resonance \textcircled{9}-2 can be improved.

Further, the GPS, the 2.4G wifi MIMO, and the 5G wifi MIMO may be implemented by using a same antenna, so that fewer antennas can be arranged in an architecture, and space occupied by the antennas can be reduced.

The following analyzes modes of the resonances in FIG. 11.

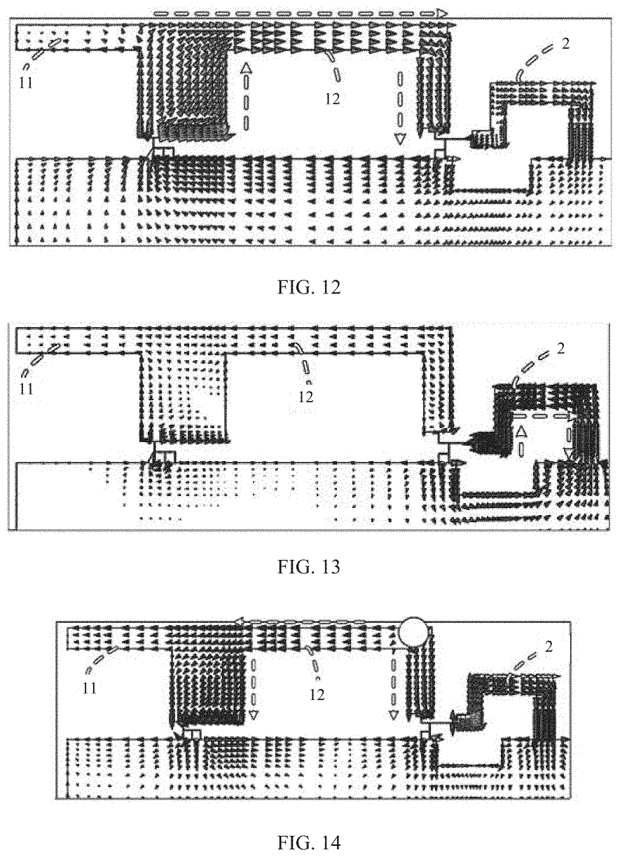

A mode of the resonance \textcircled{7} is a left-hand mode, a main radiator is the second radiation section 12, and a corresponding current distribution diagram is shown in FIG. 12. It can be learned from FIG. 12 that currents are basically distributed on the second radiation section 12.

A mode of the resonance \textcircled{9}-1 is a left-hand mode, a main radiator is the second radiator 2, and a corresponding current distribution diagram is shown in FIG. 13. It can be learned from FIG. 13 that currents are basically distributed on the second radiator 2.

A mode of the resonance \textcircled{8}-1 is a half-wavelength mode of a loop antenna, a main radiator is the second radiation section 12, and a corresponding current distribution diagram is shown in FIG. 14. It can be learned from FIG. 14 that currents are basically distributed on the second radiation section 12.

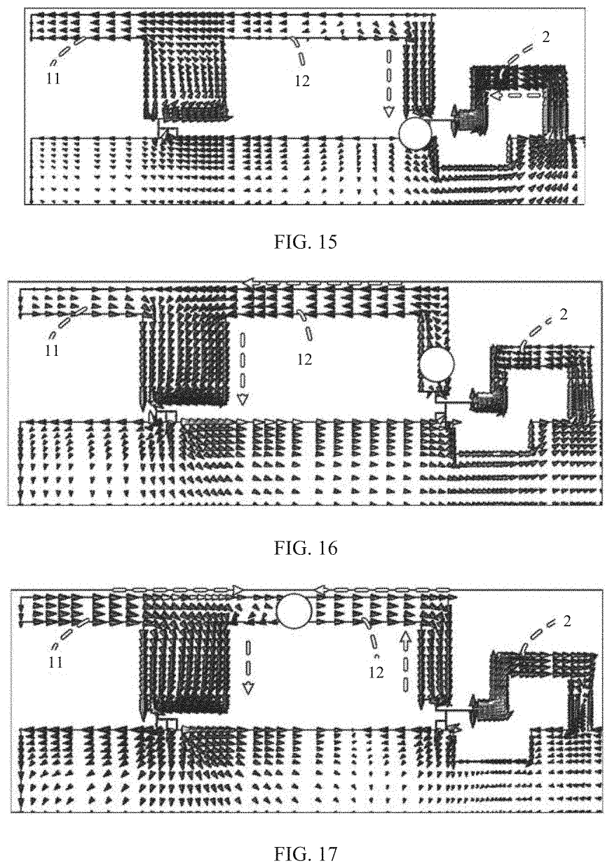

A mode of the resonance \textcircled{8}-2 is a half-wavelength mode of a loop antenna, a main radiator is the second radiator 2, and a corresponding current distribution diagram is shown in FIG. 15. It can be learned from FIG. 15 that currents are basically distributed on the second radiator 2.

A mode of the resonance \textcircled{9}-2 is a quarter wavelength mode of a unipole antenna, a main radiator is the second radiation section 12, and a corresponding current distribution diagram is shown in FIG. 16. It can be learned from FIG. 16 that currents are basically distributed on the second radiation section 12.

A mode of the resonance \textcircled{10}-1 is a half-wavelength mode of a loop antenna, a main radiator is the second radiation section 12, and a corresponding current distribution diagram is shown in FIG. 17. It can be learned from FIG. 17 that currents are basically distributed on the second radiation section 12.

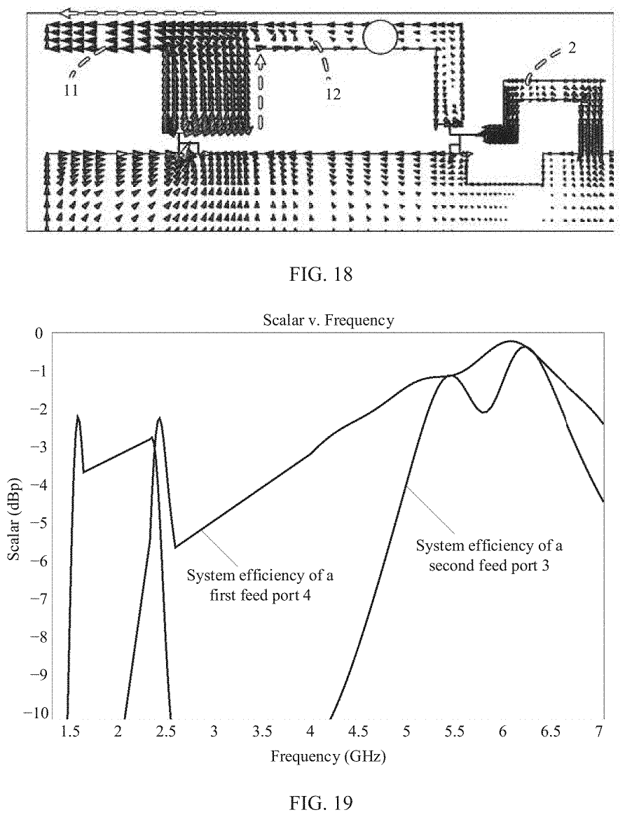

A mode of the resonance \textcircled{10}-2 is a three-quarters wavelength mode of an IFA antenna, a main radiator is the first radiation section 11, and a corresponding current distribution diagram is shown in FIG. 18. It can be learned from FIG. 18 that currents are basically distributed on the first radiation section 11.

In addition, as shown in FIG. 11, smallest isolation S21 between the resonance \textcircled{9}-1 and the resonance \textcircled{9}-2 is −8.5 dB, and isolation S21 between the resonance \textcircled{10}-1 and the resonance \textcircled{10}-2 is below −10 dB, so that a requirement of MIMO can be met.

Further, FIG. 19 is another schematic diagram of simulation system efficiency of a dual-feed dual-band MIMO antenna apparatus. As shown in FIG. 19, system efficiency of the first feed port 4 and the second feed port 3 may be determined through simulation. When efficiency is relatively high, an actual requirement can be met.

Structures of the first filter unit 6 and the second filter unit 5 in the foregoing embodiments are detailed below.

Optionally, as shown in FIG. 1A to FIG. 1C and FIG. 10, the first filter unit 6 in the foregoing embodiment includes a first inductor L1 and a first capacitor C1. A first end of the first inductor L1 is connected to the first feed port 4, a second end of the first inductor L1 is connected to a first end of the first capacitor C1, and a second end of the first capacitor C1 is grounded. In other words, the first inductor L and the first capacitor C1 are connected in series to serve as a band-pass filter, so that the band-pass filter is in a relatively simple structure form.

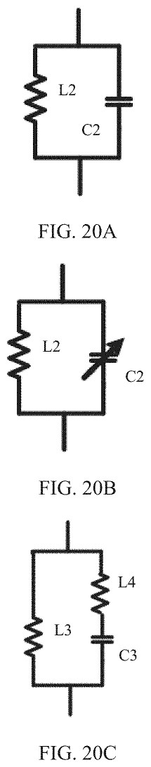

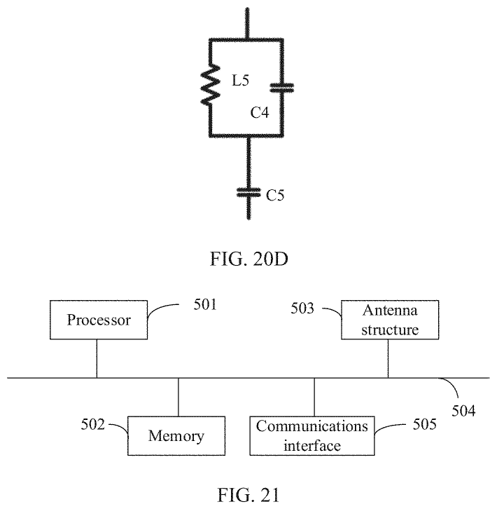

Optionally, FIG. 20A is a schematic structural diagram of a second filter unit. As shown in FIG. 20A, the second filter unit 5 in the foregoing embodiments may include a second capacitor C2 and a second inductor L2. The second capacitor C2 and the second inductor C2 are connected in parallel, the antenna radiator is separately connected to a first end of the second inductor L2 and a first end of the second capacitor C2, and the second feed port is separately connected to a second end of the second inductor L2 and a second end of the second capacitor C2. That is, the second filter unit 5 includes the second capacitor C2 and the second inductor L2 that are connected in parallel.

The second capacitor and the second inductor are connected in parallel to form the second filter unit, so as to optimize isolation.

FIG. 20B is another schematic structural diagram of a second filter unit. As shown in FIG. 20B, the second capacitor C2 may be a fixed-value capacitor or a variable capacitor.

The inductor and the variable capacitor are connected in parallel to form the second filter unit, so as to optimize isolation.

FIG. 20C is still another schematic structural diagram of a second filter unit. As shown in FIG. 20C, the second filter unit 5 in the foregoing embodiments may include a third capacitor C3, a third inductor L3, and a fourth inductor L. A first end of the third inductor L3 is separately connected to a first end of the fourth inductor L4 and the antenna radiator, a second end of the third inductor L3 is separately connected to a second end of the third capacitor C3 and the second feed port, and a second end of the fourth inductor L4 is connected to a first end of the third capacitor C3. That is, the fourth inductor L4 and the third capacitor C3 are connected in series, and then are connected to the third capacitor C3 in parallel, to jointly form the second filter unit 5.

The fourth inductor and the third capacitor are connected in series, and then are connected to the third inductor L3 in parallel, to form the second filter unit, so as to optimize isolation.

FIG. 20D is still another schematic structural diagram of a second filter unit. As shown in FIG. 20D, the second filter unit 5 in the foregoing embodiments may include a fifth inductor L5, a fourth capacitor C4, and a fifth capacitor C5. A first end of the fifth inductor L5 is separately connected to a first end of the fourth capacitor C4 and the antenna radiator, a second end of the fifth inductor L5 is separately connected to a second end of the fourth capacitor C4 and a first end of the fifth capacitor C5, and a second end of the fifth capacitor C5 is connected to the second feed port. That is, the fifth inductor L5 and the fourth capacitor C4 are connected in parallel, and then are connected to the fifth capacitor C5 in series, to jointly form the second filter unit 5.

In the foregoing solution, in a two-level low-pass high-cut filter circuit, the fifth inductor and the fourth capacitor are connected in parallel, and then are connected to the fifth capacitor in series, to form the second filter unit, so as to optimize isolation.

The second filter unit 5 may be implemented in a plurality of forms, so that a structure of the second filter unit 5 is more flexible.

In addition, it should be noted that an implementation form of the dual-feed dual-band MIMO antenna apparatus in the foregoing embodiments is not limited, and the dual-feed dual-band MIMO antenna apparatus may be implemented by a metal frame, a laser direct structuring (Laser-Direct-structuring, LDS) technology, or an MDA, and is applicable to most IDs and architecture designs.

The dual-feed dual-band MIMO antenna apparatus provided in the embodiments of this application includes the antenna radiator, the first feed port, the second feed port, the first filter unit, and the second filter unit. The first feed port and the second feed port are spaced on the antenna radiator in the length direction of the antenna radiator, and there is the spacing between the first feed port and the end of the antenna radiator. The first filter unit is disposed between the first feed port and the antenna radiator, and the second filter unit is disposed between the second feed port and the antenna radiator. The first filter unit is configured to pass the frequency component within the first preset frequency range, and filter out the frequency component outside the first preset frequency range; and the second filter unit is configured to filter out the frequency component within the second preset frequency range, and pass the frequency component outside the second preset frequency range. The first feed port and the second feed port are separately designed, but share a same radiator. In this way, the 5G wifi MIMO can be implemented on the same radiator, and the total quantity of antennas is reduced, so that not only antennas can be normally arranged in very small space, but also high performance of the antennas can be ensured.

FIG. 21 is a schematic structural diagram of an embodiment of a terminal according to this application. As shown in FIG. 21, the terminal provided in this embodiment of this application includes a processor 501, a memory 502, a dual-feed dual-band MIMO antenna apparatus 503, and a communications interface 505. The processor 501, the memory 502, the dual-feed dual-band MIMO antenna apparatus 503, and the communications interface 505 are connected by using a system bus 504. A computer program of the mobile terminal is stored in the memory 502, and the processor 501 executes corresponding computer code to perform a corresponding function, so as to control the dual-feed dual-band MIMO antenna apparatus 503 to receive or send a signal.

In a specific implementation of this application, the memory 502 may include a volatile memory, for example, a dynamic nonvolatile random access memory (Nonvolatile Random Access Memory, NVRAM), a phase-change random access memory (Phase Change RAM, PRAM), or a magnetoresistive random access memory (Magnetoresistive RAM, MRAM); or the memory 502 may include a nonvolatile memory, for example, at least one magnetic disk storage device, an electrically erasable programmable read-only memory (Electrically Erasable Programmable Read-Only Memory, EEPROM), or a flash storage device such as a NOR flash memory (NOR flash memory) or a NAND flash memory (NAND flash memory). The non-volatile memory stores an operating system and an application program that are executed by the processor. The processor 501 loads a running program and data from the non-volatile memory into a memory and stores data content in a large-capacity storage apparatus.

The processor 501 is a control center of the terminal. The processor 501 connects various parts of the entire terminal by using various interfaces and lines, and by running or executing a software program and/or an application module stored in the memory 502 and by invoking data stored in the memory 502, performs various functions of the terminal and processes the data, so as to perform overall monitoring on the terminal.

The processor 501 may include only a CPU, or may include a combination of a CPU, a graphic processing unit (Graphic Processing Unit, GPU), a DSP, and a control chip (such as a baseband chip) of a communications unit. In this implementation of this application, the CPU may be a single computing core, or may include a plurality of computing cores. In some embodiments, the processor 501 and the memory 502 may exist in a form of one device, such as a single-chip microcomputer.

The system bus 504 may be an industry standard architecture (Industry Standard Architecture, ISA) bus, a peripheral component interconnect (Peripheral Component Interconnect, PCI) bus, an extended industry standard architecture (Extended Industry Standard Architecture. EISA) bus, or the like. The system bus 504 may be classified into an address bus, a data bus, a control bus, or the like. For clear description in this embodiment of this application, various buses in FIG. 21 are marked as the bus system 504.

The antenna apparatus 503 communicates with the processor 501 through the system bus 504, and implements a communication function of the terminal under control of the processor 501.

A specific implementation of the dual-feed dual-band MIMO antenna apparatus 503 may use the technical solutions in any of the foregoing embodiments of this application. An implementation principle and a technical effect of the dual-feed dual-band MIMO antenna apparatus 503 are similar to those of the technical solutions, and details are not described herein again.

1.-17. (canceled)

18. A dual-feed dual-band multiple-input and multiple-output (MIMO) antenna apparatus comprising:
an antenna radiator comprising:
a first end; and
a second end;
a first feed port, wherein the first feed port is spaced apart from the first end;
a second feed port, wherein the first feed port and the second feed port are spaced apart on the antenna radiator in a length direction of the antenna radiator;
a first filter unit disposed between the first feed port and the antenna radiator and configured to:
pass a first frequency component within a first preset frequency range; and
filter out a second frequency component outside the first preset frequency range; and
a second filter unit disposed between the second feed port and the antenna radiator and configured to:
filter out a third frequency component within a second preset frequency range; and
pass a fourth frequency component outside the second preset frequency range.

19. The dual-feed dual-band MIMO antenna apparatus of claim 18, wherein the first filter unit comprises:
a first inductor comprising:
a third end coupled to the first feed port; and
a fourth end; and
a first capacitor comprising:
a fifth end coupled to the fourth end; and
a sixth end that is grounded.

20. The dual-feed dual-band MIMO antenna apparatus of claim 18, wherein the second feed port is located at the second end, and wherein the second end is located away from the first feed port.

21. The dual-feed dual-band MIMO antenna apparatus of claim 18, wherein the second filter unit comprises:
a second capacitor comprising:
a seventh end coupled to the antenna radiator; and
an eighth end coupled to the second feed port; and
a second inductor coupled to the second capacitor in parallel, wherein the second inductor comprises:
a ninth end coupled to the antenna radiator; and
a tenth end coupled to the second feed port.

22. The dual-feed dual-band MIMO antenna apparatus of claim 21, wherein the second capacitor comprises a fixed-value capacitor or a variable capacitor.

23. The dual-feed dual-band MIMO antenna apparatus of claim 18, wherein the second filter unit comprises:
a third capacitor comprising:
an eleventh end; and
a twelfth end;
a third inductor comprising:
a thirteenth end coupled to the antenna radiator; and
a fourteenth end coupled to the twelfth end and the second feed port; and
a fourth inductor comprising:
a fifteenth end couple to the thirteenth end; and
a sixteenth end coupled to the eleventh end.

24. The dual-feed dual-band MIMO antenna apparatus of claim 18, wherein the second filter unit comprises:
a fifth inductor comprising:
a seventeenth end coupled to the antenna radiator; and
an eighteenth end;
a fourth capacitor comprising:
a nineteenth end coupled to the seventeenth end; and
a twentieth end coupled to the eighteenth end; and
a fifth capacitor comprising:
a twenty first end coupled to the eighteenth end; and
a twenty second end coupled to the second feed port.

25. The dual-feed dual-band MIMO antenna apparatus of claim 18, wherein the second feed port and the second end are spaced apart.

26. The dual-feed dual-band MIMO antenna apparatus of claim 18, wherein the antenna radiator further comprises a first radiation section and a second radiation section that are coupled to each other, wherein the first radiation section is located on a first side of the first feed port, and wherein the second radiation section is located between the first feed port and the second feed port.

27. The dual-feed dual-band MIMO antenna apparatus of claim 26, wherein the first radiation section and the second radiation section are in an integrated structure.

28. The dual-feed dual-band MIMO antenna apparatus of claim 27, wherein the first side is located away from the second feed port.

29. The dual-feed dual-band MIMO antenna apparatus of claim 26, wherein the first radiation section and the second radiation section are located on a same side of the first feed port.

30. The dual-feed dual-band MIMO antenna apparatus of claim 18, further comprising a second radiator coupled to the second feed port.

31. The dual-feed dual-band MIMO antenna apparatus of claim 18, wherein the first feed port is a 2.4 gigahertz (GHz) WI-FI feed port, and wherein the second feed port is a Global Positioning System (GPS) feed port.

32. The dual-feed dual-band MIMO antenna apparatus of claim 18, wherein the first feed port is of a Long-Term Evolution (LTE) B8 frequency band, and wherein the second feed port is of an LTE B3 frequency band.

33. The dual-feed dual-band MIMO antenna apparatus of claim 18, wherein the first filter unit is a band-pass filter, and wherein the second filter unit is a band-stop filter.

34. A terminal comprising:
a radio frequency circuit; and
a dual-feed dual-band multiple-input and multiple-output (MIMO) antenna apparatus coupled to the radio frequency circuit and comprising:
an antenna radiator comprising:
a first end; and
a second end;
a first feed port, wherein the first feed port is spaced apart from the first end;
a second feed port, wherein the first feed port and the second feed port are spaced apart on the antenna radiator in a length direction of the antenna radiator;
a first filter unit disposed between the first feed port and the antenna radiator and configured to:
pass a first frequency component within a first preset frequency range; and
filter out a second frequency component outside the first preset frequency range; and
a second filter unit disposed between the second feed port and the antenna radiator and configured to:
filter out a third frequency component within a second preset frequency range; and
pass a fourth frequency component outside the second preset frequency range.

35. The terminal of claim 34, wherein the first filter unit comprises:
a first inductor comprising:
a third end coupled to the first feed port; and
a fourth end; and
a first capacitor comprising:
a fifth end coupled to the fourth end; and
a sixth end that is grounded.

36. The terminal of claim 34, wherein the second filter unit comprises:
a second capacitor comprising:
a seventh end coupled to the antenna radiator; and
an eighth end coupled to the second feed port; and
a second inductor coupled to the second capacitor in parallel and comprising:
a ninth end coupled to the antenna radiator; and
a tenth end coupled to the second feed port.

37. The terminal of claim 34, wherein the second filter unit comprises:
a third capacitor comprising:
an eleventh end; and
a twelfth end;
a third inductor comprising:
a thirteenth end coupled to the antenna radiator; and
a fourteenth end coupled to the twelfth end and the second feed port; and
a fourth inductor comprising:
a fifteenth end coupled to the thirteenth end; and
a sixteenth end coupled to the eleventh end.
